(19) United States
(12) Patent Application Publication
(10) Pub. No.: US 2003/0097339 A1
(43) Pub. Date: May 22, 2003

(54) Method and apparatus for sharing customer data

(76) Inventors: David A. Funck, Wheaton, IL (US); Anthony J. Dezonno, Bloomingdale, IL (US); Jeff Hodson, Wheaton, IL (US); Joseph Bloom, Libertyville, IL (US); Eric James, Elgin, IL (US); Michael Peters, Downers Grove, IL (US); Mark J. Power, Carl Stream, IL (US); Craig R. Shambaugh, Wheaton, IL (US); Dave Mosquera, West Chicago, IL (US); Nayel Saleh, Round Lake, IL (US)

Correspondence Address: Welsh & Katz, Ltd., Eric D. Cohen, 22nd Floor, 120 South Riverside Plaza, Chicago, IL, 60606, US

(21) Appl. No.: 09/992,138

(22) Filed: Nov. 16, 2001

(51) Int. Cl. G06F 17/60

(52) U.S. Cl. 705/64

(57) ABSTRACT

A telecommunication system for transmitting customer data corresponding to a customer, to an agent of an automatic call distributor (ACD) is described. The ACD is connected to the telecommunication system through a public switched telephone network (PSTN). The telecommunication system includes a customer data processor configured to maintain two way communication between the customer and the agent of the ACD, where the customer data processor stores and processes customer data provided by the customer. A data encrypter operatively coupled to the customer data processor encrypts the customer data. The customer data processor transmits the encrypted customer data to the ACD upon receiving a predetermined signal. A customer data interpreter is operatively coupled to the ACD and receives and decrypts the encrypted customer data to facilitate presentation of the customer data to the agent.

### FIELD OF THE INVENTION

The present invention relates generally to a method and apparatus for sharing customer data and more specifically to a method and apparatus that permits customer data to be transmitted from a customer to an agent of an automatic call center.

### BACKGROUND OF THE INVENTION

Systems which automatically distribute customer contacts (generically “ACD”) are often employed in telemarketing environments in which agents stationed at agent telephone sets answer many different types of telephone calls and other types of customer contacts (emails, facsimile, chat room dialog, Internet, etc.) from customers during a work day. As referred to herein, an ACD may be referred to as an automatic call distributor or an automatic contact distributor because the medium of the communication is transparent to the ACD. In other words, the ACD handles all forms of communication. In these known systems, the agent may receive certain information about the type of customer call (i.e. contact) on a visual display at the agent set when a call is distributed to the agent. The agent reads the information on the display to determine what type of call (i.e., sales, inventory, customer support, billing, etc.) he or she is receiving.

ACD's may be used to support a number of different vendors in their telemarketing effort, and in such marketing environments, the agent is typically in communication with the customer or potential customer with respect to or on behalf of a particular vendor. The next contact that the agent processes may be on behalf of the same vendor or on behalf of a different vendor. Alternatively, ACD's may be used exclusively by or on behalf of a single vendor such that all of the contacts processed by the agent involve one particular vendor.

Whether the agent processes contacts directed to a single vendor or to multiple vendors, customer information must be gathered to complete the transaction. This may be done in several ways. The agent may gather the customer information directly from the customer when speaking with the customer. The customer may provide his name, address, and credit card number, and will also specify the goods or services to purchase. The agent typically enters this information into the system. This tends to be time consuming and inefficient, which translates into higher costs and reduced profits. Additionally, this process is inherently prone to errors, as the agent may not properly record the customer information.

In other known systems, the ACD or other telemarketing system provides a prerecorded marketing script. The ACD typically plays a prerecorded message, which gives the customer specific instructions and then requests that the customer provide particular information by depressing the touch-tone keys of the telephone. The DTMF tones generated by the touch-tone keys are translated into the appropriate numbers and/or letters, and are either stored for subsequent use or processed with respect to the customer transaction. For example, the customer may be asked to chose a particular product from a list of ten products, and if the customer decides to purchase the product, he or she must select the product and enter a credit card number to secure payment. The customer may provide information, such as customer name and street address, verbally to the agent. For customers who make frequent purchases in this manner, the customer would need to provide the same information time and time again. Further, many consumers are annoyed by such requirements for data entry and often terminate the telemarketing session if required to enter data via the touch tone keys of the telephone. This results in a loss of business.

A need exists for automatically providing customer information to the agent of an ACD in an accurate and rapid manner without causing customer discontent.

### SUMMARY

The disadvantages of present methods and apparatus for providing customer data to an agent of an ACD are substantially overcome with the present invention by providing a novel method and apparatus for sharing customer data.

More specifically, an apparatus for sharing customer data according to one embodiment of the present invention utilizes a telecommunication system for transmitting customer data corresponding to a customer, to an agent of an automatic call or contact distributor (ACD). The ACD is connected to the telecommunication system through a public switched telephone network (PSTN). The telecommunication system includes a customer data processor configured to handle two way communication between the customer and the agent of the ACD, where the customer data processor stores and processes customer data provided by the customer. A data encrypter operatively coupled to the customer data processor encrypts the customer data. The customer data processor transmits the encrypted customer data to the ACD upon receiving a predetermined signal. A customer data interpreter is operatively coupled to the ACD and receives and decrypts the encrypted customer data to facilitate presentation of the customer data to the agent.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a pictorial representation of a specific embodiment of a telecommunication system showing a customer computer and an exemplary automatic call distributor;

FIG. 2 is a block diagram of a specific example of a known ACD system;

FIG. 3 is a block diagram of a specific example of the customer computer of FIG. 1;

FIG. 4 is a pictorial representation of an alternate embodiment of a telecommunication system;

FIG. 5 is a pictorial representation of an alternate embodiment of a telecommunication system; and

FIG. 6 is a pictorial representation of an alternate embodiment of a telecommunication system.

### DETAILED DESCRIPTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

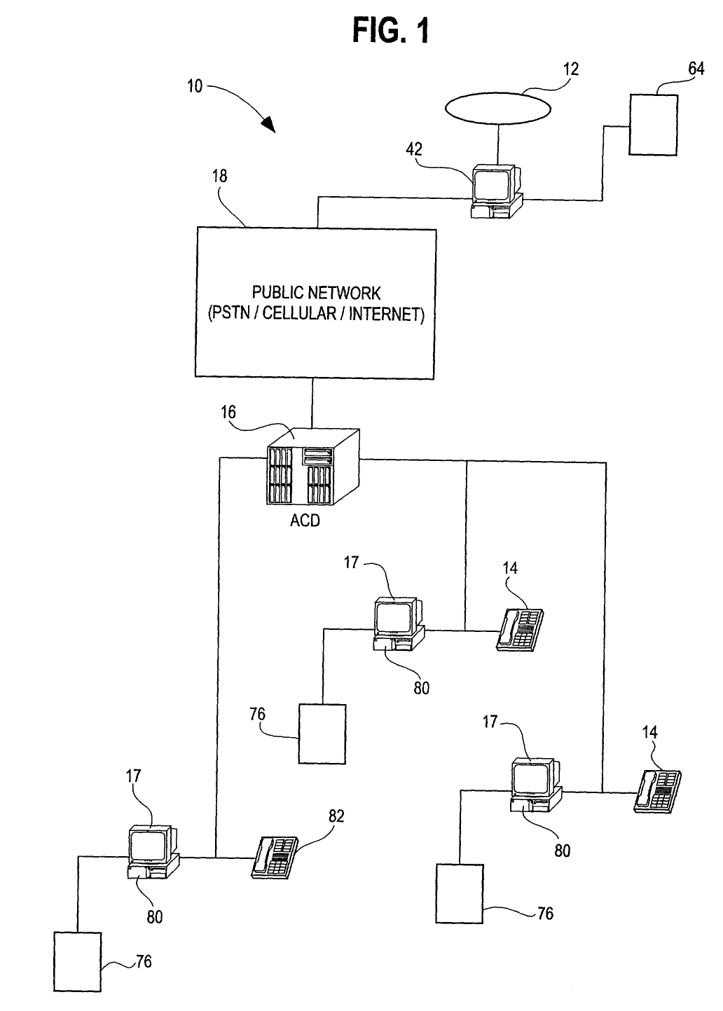

Referring now to FIG. 1, one embodiment of a telecommunication system is shown generally 10. To enhance telemarketing effectiveness, the telecommunications system 10 facilitates transmission of customer data 12 corresponding to a customer, to an agent or agent telephone set 14 of an automatic call or contact distributor (ACD) 16. The customer may be connected to the ACD 16 through a public switched telephone network (PSTN) 18, but may also be connected to the ACD through another type of communication network, such as an Internet network or a cellular telephone network.

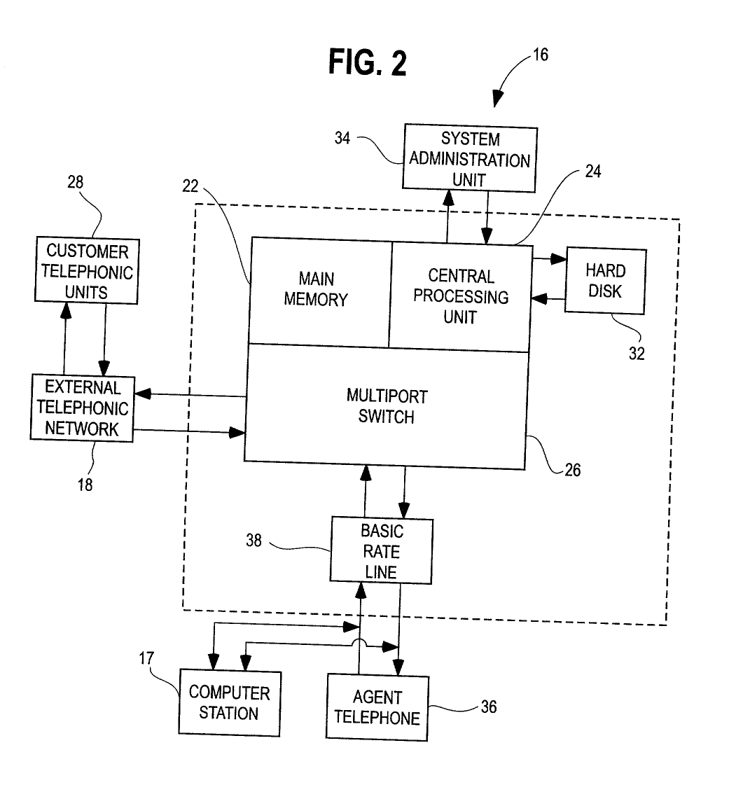

Referring now to FIG. 2, an example of a known ACD system 16 is shown generally. The ACD 16 may further include agent station computers 17 or terminals. The ACD may comprise hardware and/or software and, for example, may include a main memory 22, a central processing unit 24 and a multiport switch 26 each of which may be separate units, distributed, or integrated at a single location. The multiport switch 26 is coupled, for example, to the PSTN 18, which in turn, is connected to customer telephones 28. The central processing unit 24 may include storage, such as hard disk storage 32, and may also be coupled to a system administration unit 34. The ACD 16 is connected through a suitable communications link to a plurality of agent telephonic sets 36, for example, through a basic rate line 38 as is known in the art. The agent computer station 17 and the agent telephone sets may be incorporated into a single unit, as is known in the art.

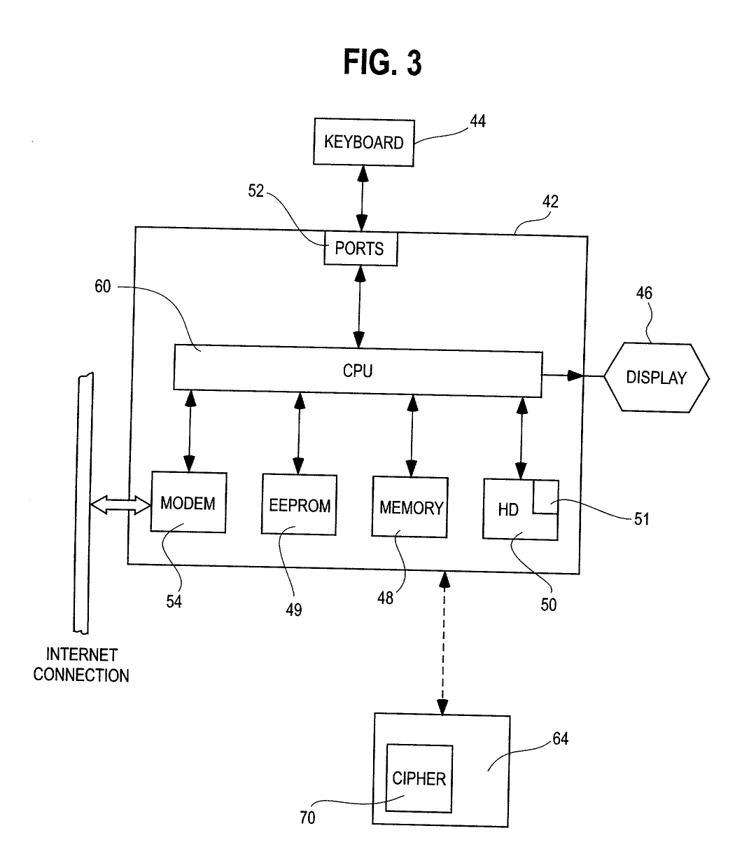

Referring to the specific embodiments of FIGS. 1 and 3, the customer communicates with the ACD 16 via a telephonic communication device, which may be a customer computer 42 (FIG. 3). The customer computer 42 may, for example, be a personal computer having a modem and voice-over internet protocol (VoIP) capability. The customer computer 42 may be, for example, an IBM brand compatible personal computer or any suitable computer capable of communication over a telephone line or the Internet. In this way, the customer verbally communicates with the agent 14 of the ACD 16 over the Internet. As shown in greater detail in FIG. 3, the customer computer 42 may include a keyboard 44, a display 46, memory 48 (such as EEPROM), hard disk storage 50, communication ports 52, a modem or network interface 54, a CPU 60, and other appropriate components, as is known in the art.

With respect to communication between the customer and the agent 14 of the ACD 16 utilizing VoIP protocol, a VoIP telephone call takes place over a computer network instead over a private telephone company special purpose phone network. To place a VoIP telephone call, the caller typically runs software which accepts audio input, digitizes that audio input, and then uses some IP-based protocol to send the audio input to the callee, as is known to one skilled in the art. The callee, in the present case, the ACD 16, preferably runs compatible software so that the audio data is received and properly decoded.

VoIP, as used in the telephone industry, describes a set of facilities for managing the delivery of voice information using the Internet Protocol (IP). In general, this means transmitting digital voice information via discrete packets rather than by the traditional circuit-committed protocols utilized in the PSTN 18. The PSTN 18 provides users with a dedicated end-to-end circuit connections for the duration of each telephone call. Circuits are reserved between the originating switch, tandem switches, and the terminating switch based on the telephone number dialed by the calling party. In the event of high utilization or network congestion, the network simply blocks (busy signal) any new calls being placed until the circuits become available. This method of congestion control is ideal for audio transmissions because it does not degrade voice quality calls that have already been established.

Unlike the circuit-switched PSTN, however, packet switched Internet Protocol networks provide virtual circuit connections between the users. Bandwidth is shared for improved utilization of network capacity leading to lower costs for network users. Individual packets are routed to their destination IP address contained in the packet's header, and may travel over different network paths before arriving at their final destination for re-assembly and re-sequencing. When high utilization or network congestion occurs in a packet-switched network, voice users may experience variations in transmission speeds, which can degrade voice quality. Existing protocols, such as H.323 may be used to implement VoIP methods and apparatus described herein. The present invention contemplates utilizing future improvements in VoIP and the supporting infrastructure.

Referring to FIGS. 1 and 3, the customer computer 42 is adapted to handle communication with the agent 14 of the ACD 16, and either the customer computer or the ACD may initiate the telephone call. The customer computer 42 may include a customer data processor 64 operatively coupled to the customer computer for storing and processing the customer data 12 provided by the customer. Preferably, the customer data processor 64 is part of the customer computer 42 and is implemented as a software program that runs on the customer computer. As such, the customer data processor 64 may share memory and/or hard disk storage space with the customer computer 42. In this embodiment, the customer data processor 64 may be a “virtual” processor, as it may be the microprocessor that forms the customer computer. The customer data processor 64 may be any form of processing or computing device.

In another embodiment, the customer data processor 64 may be separate from the customer computer 42, and may be constructed as a single chip microprocessor with an alphanumeric keypad (not shown) and appropriate non-volatile storage, such as EEPROM. In such an embodiment, the customer data processor 64 may communicate with the customer computer 42 through a serial port (not shown), as is known in the art. Whether the customer data processor 64 is the part of or separate from customer computer 42 does not change or limit the scope of the present invention. The term “customer data processor 64” and customer computer 42 are used interchangeably herein, whether implemented as one component or two separate components.

The customer data processor 64 receives, stores and processes the customer data 12, such as customer name, customer address, customer telephone number, credit card number, customer purchase history, customer complaint history, preferred agent and customer preferences. Some or all of this data, and other data not specifically enumerated above, may be stored by the customer data processor 64. Initially, the customer data 12 is entered into the customer data processor 64 by the customer. In the illustrated embodiment, the customer may enter the customer data 12 via a standard input device, such as a keyboard 44. The customer data 12 is retained in memory, such as on the hard disk 50 as a file or a database 51 of the customer computer 42 for subsequent transmission to the ACD 16.

In operation, to facilitate a marketing transaction, such as a customer purchase, the customer data 12 is transmitted (or caused to be transmitted) by the customer data processor 64 to the ACD 16. This saves the telemarketing agent 14 or vendor substantial time, effort and expense because the agent need not enter the pertinent customer information by hand. The transaction may be completed by the agent 14 in far less time than usual because the agent need not enter the customer name, credit card information, shipping address, and other information required to complete a sales transaction.

Because of privacy concerns, the customer computer 42 or customer data processor 64 may include a data encryption device 70 configured to encrypt the customer data 12, which data encryption device may be operatively coupled to the customer data processor 64 or to the customer computer 42. Preferably, the data encryption device is a separate chip or component coupled to the customer data processor 64, as shown in FIG. 3, or may reside on a “board” within the customer data processor. The data encryption device 70 preferably uses the PGP or DES encryption format, but any suitable data encryption protocol may be used.

In operation, communication between the customer and the agent 14 of the ACD 16 may be established by either the customer or the agent. Either the agent 14 is promoting a product or service to the customer, or the customer is inquiring about purchasing a product or products. In either case, the transaction is largely complete when the consumer purchases the product and provides payment in the form of a credit card number.

Accordingly, the customer agrees, either explicitly or implicitly, to supply the customer data 12 to the agent 14. This may occur in any one of the suitable ways known in the art. In one embodiment, the customer issues a predetermined signal to facilitate automatic transmission of the customer data 12 to the ACD 16 at some point during the transaction with the agent. This may be as simple as the Customer depressing a key sequence on the keyboard of the customer computer 42, or by clicking on a dialog box displayed on the display 46 of the customer computer 42 to initiate transmission of the customer data 12 to the ACD 16.

In another specific embodiment, the ACD 16 may send a code or predetermined signal to the customer computer 42, which if verified by the customer computer, causes the customer data 12 to be automatically and transparently sent to the ACD 16. Of course, the customer data 12 is encrypted prior to transmission. The data transmission may be performed prior to establishing VoIP voice communication between the customer and the agent 14, during the voice communication, or after the voice communication has terminated. In this embodiment, the ACD 16 may further transmit a vendor identification code or other vendor identifier to the customer computer 42, which may provide the customer with the identity of the particular vendor to which the transaction is directed. Depending upon the vendor with whom the customer is dealing, the customer may desire differing levels of security. Alternately, the customer may not want to have any involvement with a particular vendor, and in such a case, may not transmit the customer data 12 to the ACD 16.

The database 51 (FIG. 3) in the customer computer 42 may contain various codes associated with a predetermined security level that corresponds to each vendor code or vendor identifier in a list of vendor codes or identifiers. Any suitable number of security levels may be assigned, which security levels may be assigned by the customer or may be automatically assigned by the customer computer 42. For example, three levels of security may exist for a particular vendor code, namely a first security level, a second security level and a third security level. If the customer computer 42 receives a vendor code corresponding to the first security level, which means that the vendor is a highly trusted vendor, then all of the customer data 12 may be transmitted to the agent 14 of the ACD 16.

If the vendor code corresponds to the second security level, only a predetermined portion of the customer data 12 may be transmitted to the agent 14 of the ACD 16. For example, the credit card number may be omitted from the transmission of the customer data 12. This may occur if the customer has not had prior dealings with the particular vendor and is not aware of the vendor's reputation.

If the vendor code corresponds to the third security level, only very limited information may be transmitted to the agent 14 of the ACD 16, or perhaps no information at all is transmitted. Of course, the customer may decide which data is transmitted depending upon the security level associated with the vendor code.

The ACD 16 includes a customer data interpreter 76 for receiving and decrypting the encrypted customer data 12 to facilitate presentation of the customer data to the agent 14. The customer data interpreter 76 may be part of the ACD 16 or may be separate from the ACD and operatively coupled to the ACD. Alternatively, the customer data interpreter 76 may be part of the agent station computer 17. The customer data interpreter 76 may receive the encrypted customer data 12 and apply a corresponding decryption algorithm. Once the customer data 12 has been decrypted, the ACD 16 provides the customer data to the agent via the agent display. The received customer data may be formatted so that the pertinent customer data is entered into a customer order form to facilitate rapid execution of the telemarketing transaction, Note that in the illustrated embodiment of FIG. 1 and other embodiments described herein, only three agent stations 17 are shown connected to the ACD 16 for purposes of illustration only, as it is know that many agents stations may be connected to the ACD. Each agent station may include the computer 17, the customer data interpreter 76, a telephone set 14, and customer data storage 80. The customer data storage 80 may be part of the agent computer 17. Alternatively, the agent computer 17 may be replaced by an agent terminal, as is known in the art. Further, the ACD 16 may include a VoIP telephone set 82 coupled to the agent computer.

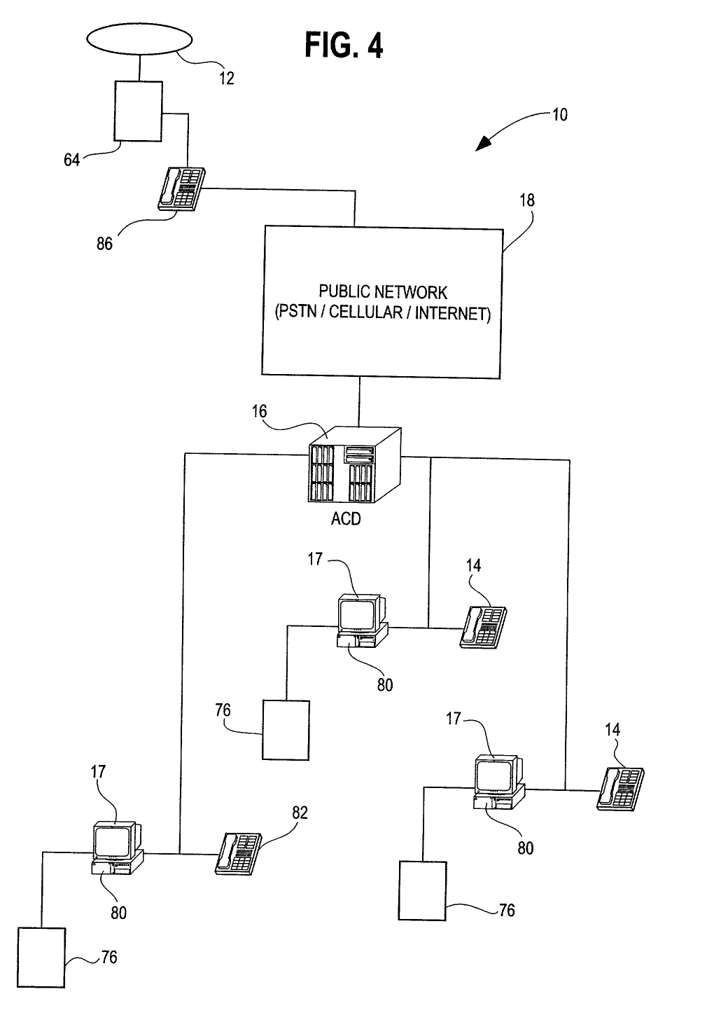

Referring now to FIG. 4, an alternate embodiment is shown that includes a VoIP telephone 86 coupled to the ACD 16 via the PSTN 18. In this embodiment, the customer computer 42 or customer data processor 64 of FIG. 1 is incorporated into the VoIP telephone 86. In a VoIP telephone 86, when the customer places as telephone call, the VoIP telephone is automatically connected via an Internet IP connection in the same way that a computer may be connected to the Internet. Accordingly, the customer data processor 64 within the VoIP telephone 86 may transmit the customer data 12 to the ACD in the same way as described above with respect to the illustrated embodiment of FIG. 1.

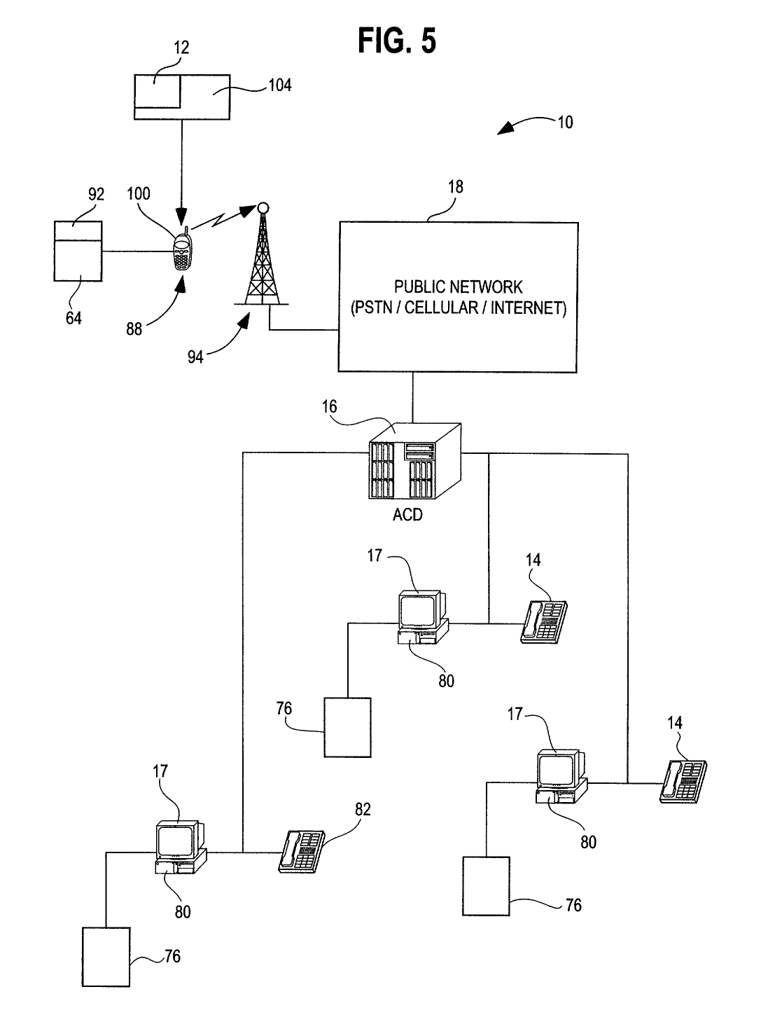

Referring now to FIG. 5, an alternate embodiment is shown where the customer connects to the ACD 16 using a cellular telephone 88. In this embodiment, the cellular telephone 88 contains the customer data processor 64 and customer data memory 92. One suitable transmission protocol for transmission of data through a cellular network is WAP (wireless application protocol). The customer data processor 64 within the cellular telephone 88 processes the customer data 12 and may transmit that data to the ACD 16 via a cellular telephone network 94 in a manner similar to that described above. The customer may enter the customer data 12 into the customer data processor 64 via a cellular telephone keypad 100, or the customer data may be downloaded into the customer data processor via a link to a personal computer (not shown), as is known in the art.

Alternately, the cellular telephone may be coupled to a personal digital assistant (PDA) 104, such as a PALM PILOT or other suitable PDA. In such an embodiment, the PDA 104 may store the customer data and transfer the customer data to the cellular telephone 88 for transmission to the ACD 16.

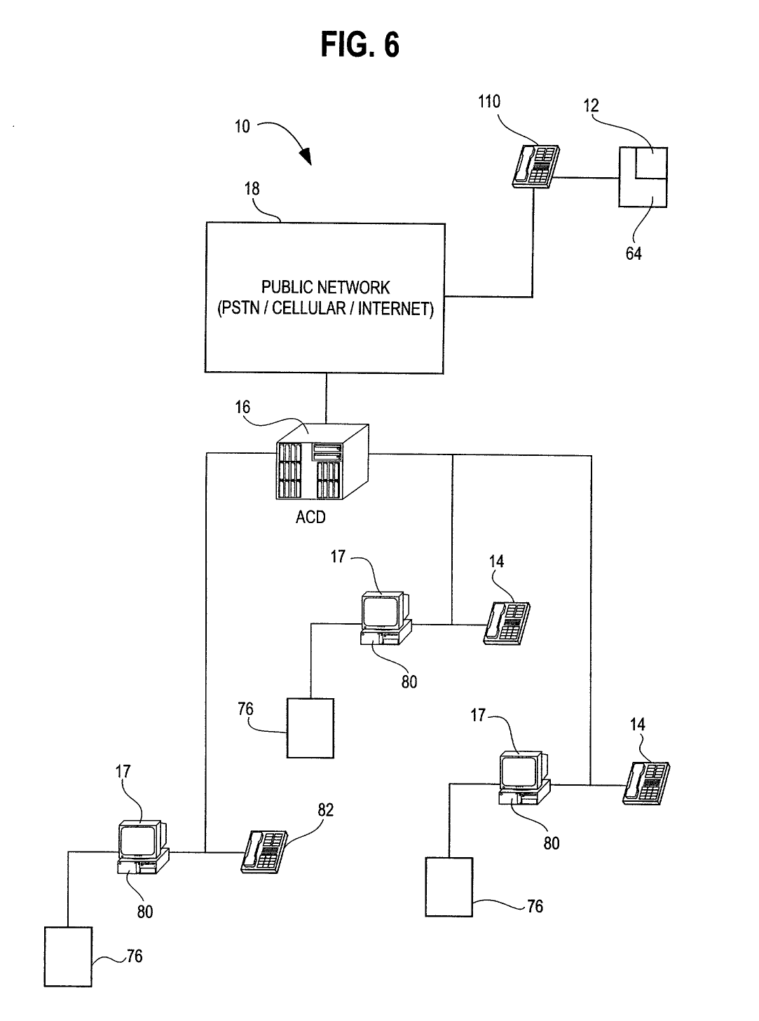

Referring now to FIG. 6, an alternate embodiment is shown where the customer connects to the ACD 18 using a POTS telephone 110. In this embodiment, the customer data processor 64 may be separate from the POTS telephone 110 and operatively coupled thereto, or may be incorporated within the housing of the POTS telephone. In this embodiment, the customer data processor 64 is coupled to the DTMF generator within the POTS telephone so that upon receipt of the appropriate signal as described above with respect to FIG. 1, the customer data 12 is transmitted to the ACD 16 as a sequence of DTMF tones. In this way, voice communication occurs over the PSTN dedicated circuit and data is sent simultaneously.

In another alternate embodiment of FIG. 6, the POTS telephone 110 may include an internal modem that connects to the ACD 16 through the PSTN 18, which connection is known in the art. The modem may be configured to convert the customer data from binary information into bitstream data, and transmit the data to the ACD 16. The modem may use, for example, V.90 protocol.

Specific embodiments of a method and apparatus for sharing customer data according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A telecommunication system for transmitting customer data corresponding to a customer, to an agent of an automatic call distributor (ACD), the ACD connected to the telecommunication system through a public switched telephone network (PSTN), the telecommunication system comprising:
a customer data processor configured to handle two way communication between the customer and the agent of the ACD, the customer data processor configured to store and process customer data provided by the customer;
a data encrypter operatively coupled to the customer data processor and configured to encrypt the customer data;
the customer data processor configured to transmit the encrypted customer data to the ACD upon receiving a predetermined signal; and
a customer data interpreter operatively coupled to the ACD for receiving and decrypting the encrypted customer data to facilitate presentation of the customer data to the agent.

2. The system according to claim 1 wherein the ACD transmits the predetermined signal to the customer data processor causing the customer data to be automatically transmitted to the ACD and presented to the agent.

3. The system according to claim 1 wherein the customer data is sent to the ACD prior to the two way communication between the customer and the agent.

4. The system according to claim 1 wherein the customer data is automatically transmitted to the agent of the ACD prior to a voice communication between the customer and the agent.

5. The system according to claim 1 wherein the customer data is sent to the ACD during the two way communication between the customer and the agent.

6. The system according to claim 1 wherein the customer data is sent to the ACD substantially simultaneously with the two way communication between the customer and the agent.

7. The system according to claim 1 wherein the customer data is automatically transmitted to the agent of the ACD after voice communication between the customer and the agent has terminated.

8. The system according to claim 1 wherein the customer issues the predetermined signal to facilitate automatic transmission of the customer data to the ACD.

9. The system according to claim 1 wherein the customer data is selected from the group consisting of a name, address, telephone number, credit card number, customer purchase history, customer complaint history, preferred agent and customer preferences.

10. The system according to claim 1 wherein the ACD transmits a vendor identification code to the customer data processor, the vendor identification code identifying a specific vendor associated with the communication between the customer and the agent.

11. The system according to claim 10 wherein the customer data processor assigns one of a plurality of security levels to the vendor identification code.

12. The system according to claim 10 wherein one of a first security level, a second security level and a third security level is assigned to the vendor identification code, such that all of the customer data is transmitted to the agent if the vendor identification code is assigned the first security level, a predetermined portion of the customer data is transmitted to the agent if the vendor identification code is assigned the second security level, and none of the customer data is transmitted to the agent if the vendor identification code is assigned the third security level.

13. The system according to claim 1 wherein the customer data processor communicates with the ACD using a voice-over internet protocol (VoIP).

14. The system according to claim 1 wherein the customer data processor is a voiceover internet protocol (VoIP) telephone.

15. The system according to claim 1 wherein the customer data processor is contained within a voice-over internet protocol (VoIP) telephone.

16. The system according to claim 1 wherein the customer data processor includes a computer and a modem configured to facilitate communicate between the customer and the agent of the ACD.

17. The system according to claim 1 wherein the customer data processor is operatively coupled to a POTS (plain old telephone service) device.

18. The system according to claim 17 wherein the customer data processor transmits the customer data using a plurality of DTMF tones.

19. The system according to claim 1 wherein the customer data processor is operatively coupled to a mobile telephone.

20. The system according to claim 1 wherein the customer data processor is contained within the mobile telephone.

21. The system according to claim 1 wherein the customer data computer is contained within a personal digital assistant (PDA) operatively coupled to a mobile telephone such that the PDA contains the customer data.

22. A telecommunication system for transmitting customer data corresponding to a customer, to an agent of an automatic call distributor (ACD), the ACD connected to the telecommunication system through a public switched telephone network (PSTN), the telecommunication system comprising:
a telephonic communication device configured to handle two way communication between the customer and the agent of the ACD;
a customer data processing means for storing and processing customer data provided by the customer;
the customer data processing means operatively coupled to the telephonic communication device;
the telephonic communication device encrypting the customer data and transmitting the encrypted customer data to the ACD upon receiving a predetermined signal; and
a customer data interpreter operatively coupled to the ACD for receiving and decrypting the encrypted customer data to facilitate presentation of the customer data to the agent.

23. A telecommunication system for transmitting customer data corresponding to a customer, to an agent of an automatic call distributor (ACD), the ACD connected to the telecommunication system through a public switched telephone network (PSTN), the telecommunication system comprising:
a telephonic communication device adapted to handle communication between the customer and the agent of the ACD using voice-over internet protocol (VoIP);
a customer data processor operatively coupled to the telephonic communication device for storing and processing customer data provided by the customer;
a data encryption device operatively coupled to the customer data processor and configured to encrypt the customer data;
the telephonic communication device configured to transmit the encrypted customer data to the ACD upon receiving a predetermined signal; and
a customer data interpreter operatively coupled to the ACD configured to receive and decrypt the encrypted customer data and present the customer data to the agent.

24. A method for transmitting customer data corresponding to a customer, to an agent of an automatic call distributor (ACD), the ACD connected to the telecommunication system through a public switched telephone network (PSTN), the method comprising the steps of:
providing a voice-over internet protocol (VoIP) communication device, the VoIP communication device adapted to handle communication between the customer and the agent of the ACD;
storing customer data provided by customer, in a customer data processor of the telephonic communication device, the customer data processor operatively coupled to the telephonic communication device;
encrypting the customer data;
transmitting the encrypted customer data to the ACD upon receiving a predetermined signal;
receiving and decrypting the customer data by a customer data interpreter, the customer data interpreter operatively coupled to the ACD; and
presenting the decrypted customer data to the agent of the ACD.

25. The method according to claim 24 wherein the ACD transmits the predetermined signal to the customer data processor causing the customer data to be automatically transmitted to the ACD and presented to the agent.

26. The method according to claim 24 wherein the customer data is automatically transmitted to the agent of the ACD prior to a voice communication between the customer and the agent.

27. The method according to claim 24 wherein the customer issues the predetermined signal to facilitate automatic transmission of the customer data to the ACD.

28. The method according to claim 24 wherein the customer data is selected from the group consisting of a name, address, telephone number, credit card number, customer purchase history, customer complaint history, preferred agent and customer preferences.

29. The method according to claim 24 wherein the ACD transmits a vendor identification code to the customer data processor, the vendor identification code identifying a specific vendor associated with the communication between the customer and the agent.

30. The method according to claim 29 wherein the customer data processor assigns one of a plurality of security levels to the vendor identification code.

31. The method according to claim 29 wherein one of a first security level, a second security level and a third security level is assigned to the vendor identification code, such that all of the customer data is transmitted to the agent if the vendor identification code is assigned the first security level, a predetermined portion of the customer data is transmitted to the agent if the vendor identification code is assigned the second security level, and none of the customer data is transmitted to the agent if the vendor identification code is assigned the third security level.

32. The method according to claim 24 wherein the customer data processor is operatively coupled to a POTS (plain old telephone service) device.

33. The method according to claim 32 wherein the customer data processor transmits the customer data using a plurality of DTMF tones.

34. The method according to claim 24 wherein the customer data processor is operatively coupled to a mobile telephone.

35. The method according to claim 24 wherein the customer data computer is contained within a personal digital assistant (PDA) operatively coupled to a mobile telephone such that the PDA contains the customer data.

36. A telecommunication system for transmitting customer data corresponding to a customer, to an agent of an automatic call distributor (ACD), the ACD connected to the telecommunication system through a public switched telephone network (PSTN), the telecommunication system comprising:
a customer processing means configured to handle two way communication between the customer and the agent of the ACD, the customer processing means configured to store and process customer data provided by the customer;
means for encrypting the customer data, the means for encrypting operatively coupled to the customer processing means;
the customer processing means configured to transmit the encrypted customer data to the ACD upon receiving a predetermined signal; and
a customer data interpreter operatively coupled to the ACD for receiving and decrypting the encrypted customer data to facilitate presentation of the customer data to the agent.

37. The system according to claim 36 wherein the ACD transmits the predetermined signal to the customer processing means causing the customer data to be automatically transmitted to the ACD and presented to the agent.

38. The system according to claim 36 wherein the customer issues the predetermined signal to facilitate automatic transmission of the customer data to the ACD.

39. The system according to claim 36 wherein the customer data is selected from the group consisting of a name, address, telephone number, credit card number, customer purchase history, customer complaint history, preferred agent and customer preferences.

40. The system according to claim 36 wherein the ACD transmits a vendor identification code to the customer processing means, the vendor identification code identifying a specific vendor associated with the communication between the customer and the agent.

41. The system according to claim 40 wherein the customer processing means assigns one of a plurality of security levels to the vendor identification code.

42. The system according to claim 36 wherein the customer processing means communicates with the ACD using a voice-over internet protocol (VoIP).

43. The system according to claim 36 wherein the customer processing means is a voice-over internet protocol (VoIP) telephone.

44. The system according to claim 36 wherein the customer processing means is contained within a voice-over internet protocol (VoIP) telephone.

45. The system according to claim 36 wherein the customer processing means is operatively coupled to a mobile telephone.

46. The system according to claim 17 wherein the POTS device includes a modem configured to convert the customer data into bitstream data and transmit the converted data to the ACD.
